(19) United States
(12) Patent Application Publication
(10) Pub. No.: US 2002/0125372 A1
(43) Pub. Date: Sep. 12, 2002

(54) Computer controlled aircraft fire sprinkler system and smoke expulsion mechanism

(76) Inventor: Henry Shooflar, (US)

Correspondence Address: HENRY SHOOFLAR, 2520 DELORIMIER, LONGUEUIL, QC, J4K3P6, CA

(21) Appl. No.: 09/793,551

(22) Filed: Feb. 27, 2001

Related U.S. Application Data
(60) Provisional application No. 60/185,854, filed on Feb. 29, 2000.

(30) Foreign Application Priority Data
Feb. 24, 2000 (CA) 2,299,673

(51) Int. Cl. B64D 45/00; A62C 3/07

(52) U.S. Cl. 244/129.2; 169/62

(57) ABSTRACT

A mechanically operable actuating device for opening a circular entry in the fuselage wall of an Aircraft. This device moves a plug attached to the shaft of a pneumatic piston inwards to expose an opening which allows smoke from a fire in any area of the plane to be expelled outside through a network of flexible tubing and computer directed shut off valves and nozzles that route the smoke outside by the nearest mechanism automatically. The smoke expulsion is achieved by the huge pressure differentially inside the plane and the outside forcing the mixture of smoke and pressurized air outside. When a plane on fire lands at an Airport the Firefighters attach hoses with an interlocking Storz receiving adapter that permits interior water spraying on the burning passengers by the same tubing network. The Flight Deck Computer controls all operations but the Pilot may alter any move. A back up Computer is located in the cabin.

### BACKGROUND OF THE INVENTION

There were a number of fires that were comparatively small that turned into major conflagrations once the doors of the Aircraft were opened and fresh oxygen rushes in to feed the flames. Some planes have exploded following such incidents.

When a plane in distress lands the Smoke Hole openings should be opened in full to allow fire hoses from the outside to be able to spray a medium force of the water and/or foam from as much as 10 openings in the different parts of the Aircraft.

At present the Fire crews can only fire water or foam on the exterior of the plane or through an open door if the fuselage is still intact.

The problem with shooting water or foam through the open doors is that you cannot do this during that critical three minute interval when all the passengers and crews are scrambling to get off the plane. This means if some of the passengers clothing is on fire and they are still far from a clogged exit, nothing can be done for them by the firefighters whose mandate is to fight the fire from the outside of the aircraft. Firefighters who have gone inside to fight a blaze have done so voluntarily and unfortunately some of these gallant men died while doing so.

### SUMMARY OF THE INVENTION

The device called a smoke hole relates to equipment and support apparatus for opening an entry outside the fuselage of an aircraft.

Smoke and fire in an aircraft in flight has always been a dreaded problem that to date does not have a satisfactory solution.

The object of this invention is to expel smoke fumes from an aircraft on fire in the same region where the fire is originating.

The smoke is expelled by utilizing the extreme difference in pressure between the inside of the aircraft and the rarified air outside.

This system does not attempt to replace any of the existing systems of smoke clearance that works with the aircrafts air-conditioning system. This system is very good but is not sufficient in clearing the air in a specific region of the plane.

In the past the circuitry of the hoses the valves and faucets were made on the blue print diagrams then a small replica of the aircraft was constructed and tests to determine air-worthiness and other attributes were conducted.

Now the method for developing prototypes and components in aircraft is done almost entirely by computer.

The operation of this system is completely Computer controlled. The system described is for the fuselage with certain extensions in key areas such as the Flight Deck wall which houses a lot of wiring.

Even though the diagrams do not show every possible extension of this system it is within the spirit of the Invention that extensions of the system would be logical in the tail section, the wings or any other area of the Aircraft.

THE PARTS OF THE SMOKE HOLE MECHANISM ARE LISTED ON THE INDEX OF SMOKE HOLE MECHANISM ANS STORZ PARTS ON PAGE 10 sheet 1 of 1.

The first 21 numerals are prefixed by an (S) which stands for Smoke Role Mechanism.

Item's 22 and 23 are AIRPORT hoses with an integrated fire hose ADAPTER AND ARE PREFIXED BY AN (A) to indicate AIRPORT EQUIPMENT.

The (S 1) Pneumatic piston controls the (S 3) a piston plug which is attached to the (S 4) a piston rod the opening procedure. The (S 4) piston rod retracts into the body of the (S 1) bimba piston and rests on top of the (S 5) center base plate which is held in place by the (S 6) support bars that also support the (S 7) support plate that holds the bottom of the bimba piston (S 1) in place.

THE TOP OF THE MECHANISM HOUSES THE Porthole (S 8) when the PISTON PLUG IS IN THE OPEN POSITION IT IS RESTING ON TOP OF THE (S 5) center base plate.

THE AREA OF EXPOSED SPACE BETWEEN THE (S 5) CENTER BASE PLATE AND THE (S 16) PORTHOLE OPENING IS CALLED THE (S 9) CAVITY ZONE. THE (S2) TUBING HOSE CONNECTIONS ARE OPENINGS ON BOTH SIDES OF THE CAVITY ZONE THAT CONNECT TO FLEXIBLE TUBING DESIGNATED (6) IN THE TUBING NETWORK THAT FORMS THE OPERATIONAL SYSTEM FOR THE DC-10-30- F PROTOTYPE.

A MORE DETAILED DESCRIPTION OF THE SMOKE HOLE ASSEMBLY OPERATION IS GIVEN IN EARLIER CLAIMS LISTED ON PAGE 1.

### BRIEF DESCRIPTION OF THE DRAWINGS

Earlier versions of the Smoke Hole Mechanism listed on the first page and prefixed by the letter (E) for earlier version. These earlier versions were Smoke Expulsion Mechanisms only.

All the other versions are Fire Sprinkler Systems as well as Smoke Expulsion devices.

The present version is also a computer controlled smoke expulsion system and fire sprinkler system just as the title indicates.

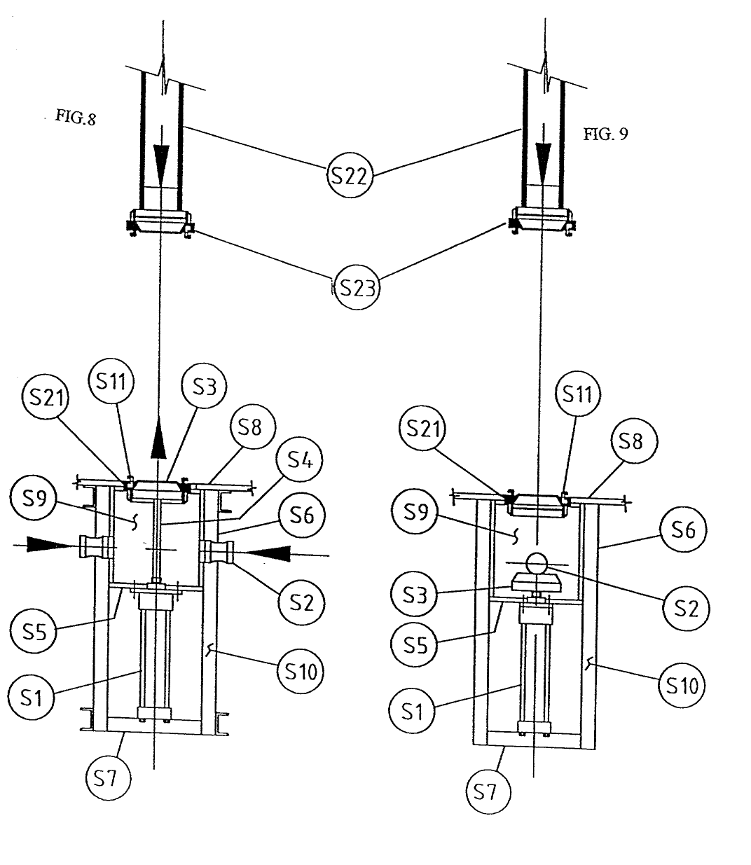

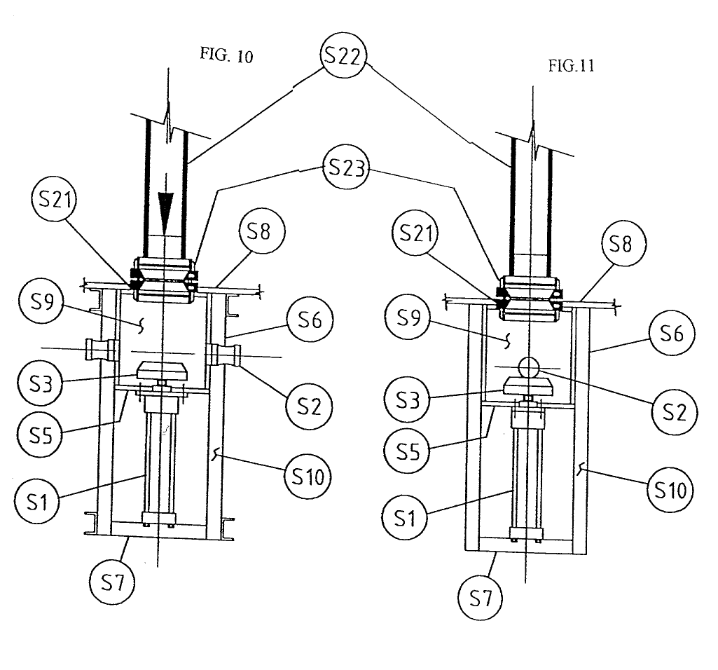

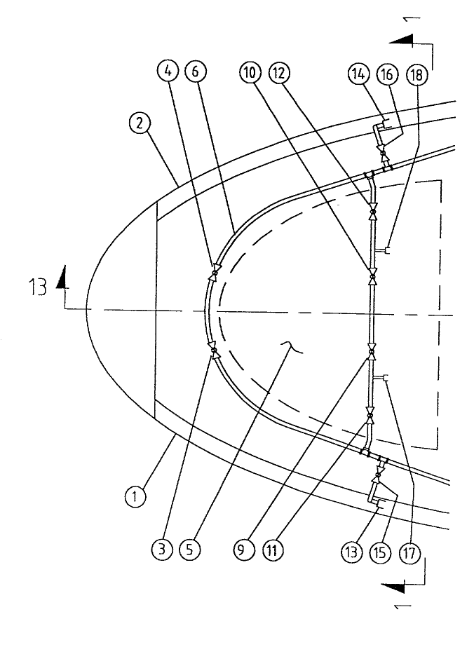

AIRPORT FIREFIGHTING REQUIRED THE INTEGRATION OF THE MODIFIED STORZ ADAPTER PAGE 17 sheet 2 of 4 FIGS. 5, 6, and 7. THIS MODIFICATION WAS DONE IN A MACHINE SHOP WHERE THE (S 19) EXTRANEOUS LUGS WERE REMOVED.

THE POLISHED STORZ ADAPTER (S 21) WAS THEN WELDED TO THE CIRCULAR OPENING IN THE PORTHOLE PLATE (S 21) MAKING THE SMOKE HOLE MECHANISM READY TO RECEIVE A FIRE HOSE WITH A RECIPROCAL HOSE CONNECTING ADAPTER ATTACHED.

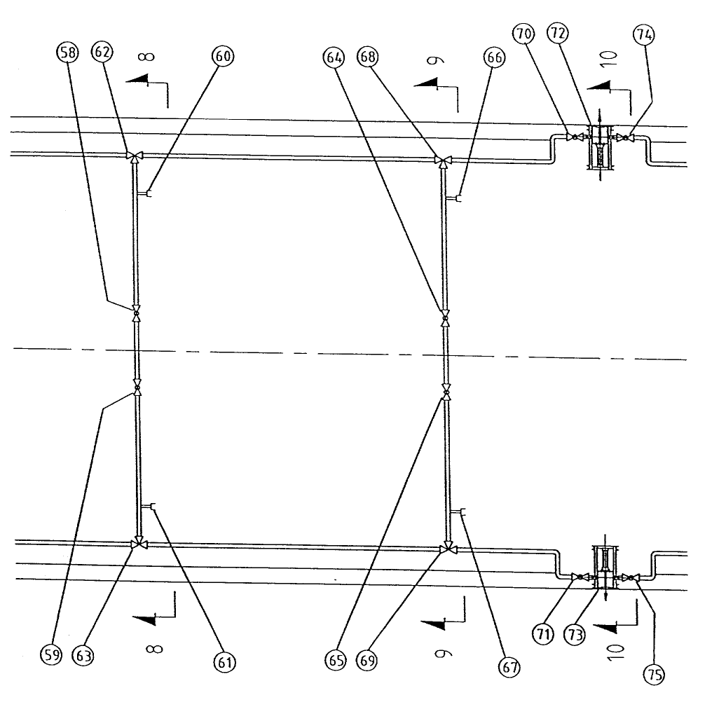

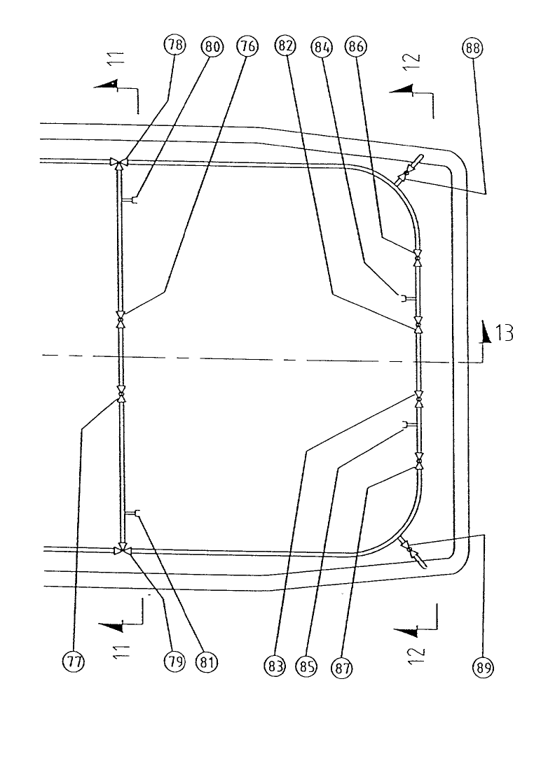

THE CONNECTION OF THE AIRPORT FIRE HOSE TO THE RECIPROCAL ADAPTER ON THE SMOKE HOLE MECHANISM IS DESCRIBED ON PAGES 18 sheet 3 of 4 in the hose approach stage and on page 19 sheet 4 of 4 FIGS. 10 and 11 for the interlocking stage which allows water entry to all areas of the aircraft within the tubing network shown in various views on pages 21 onwards.

### DETAILED DESCRIPTION OF THE DRAWINGS

### Index of Smoke Hole Mechanism and Adapter Parts

THE (S) PREFIXED BEFORE A NUMBER MEANS A SMOKE HOLE MECHANISM PART WHILE THE (A) PREFIX MEANS AN AIRPORT HOSE AND ADAPTER.

S 1. The MFI Bimba piston

S 2. Tubing hose connection

S 3. Piston plug

S 4. Piston rod

S 5. The center base plate. This contains the top of the piston and allows the piston rod (4) to go to the top of the mechanism adapter inside the plate.

S 6. Support bars for the mechanism

S 7. Bottom support plate

S 8. Porthole plate

S 9. The cavity zone

S 10. The complete Smoke Hole mechanism

The modified Storz adapter and coupling parts:

S 11. Elevated lug

S 12. Exterior rubber seal

S 13. Valley

S 14. Valley lug entry

S 15. Ridge

S 16. Porthole opening. This is where the piston plug (3) will enter.

Bottom view of the modified Storz adapter items:

S 17. Depressed outer ridge

S 18. Interior rubber seal

S 19. Extraneous bottom lugs. (The extraneous lugs were removed at the machine shop)

S 20. Elevated inner ridge

S 21. The Modified Storz Adapter. (The polished and adjusted Storz Adapter was then inserted and welded to the porthole plate (8) by Molner and Sons, a modem machine shop with aircraft parts experience.

Interlocked and pre-interlocked connections with an extended airport fire hose:

A 22. Airport fire hose

A 23. Storz fire hose adapter coupling

Numerical equipment list for the Smoke Hole System integrated in a DC-10-30-F aircraft. “A”designation in a code numeral identifies a lower deck location.

Flight deck Plan view Lower Deck Cross view

Sections 1:

| Code: | Code: |
|---|---|
| 1. Interior fuselage wall | 1A |
| 2. Exterior fuselage wall | 2A |
| 3. Open and close valve | 3A |
| 4. Open and close valve | 4A |
| 5. Flight deck | 5A |
| 6. Flexible tubing | 6A |
| 7. Sub level tubing link | 7A |
| 8. Sub level tubing link | 8A |
| 9. Open and close valve | 9A |
| 10. Open and close valve | 10A |
| 11. Open and close valve | 11A |
| 12. Open and close valve | 12A |
| 13. Nozzle in the fuselage wall | 13A |
| 14. Nozzle in the fuselage wall | 14A |
| 15. Open and close valve | 15A |
| 16. Open and close valve | 16A |
| 17. Nozzle in flight deck area | 17A |
| 18. Nozzle in flight deck area | 18A |
| 19. Main control computer | 19A |
| 20. Internal flight deck wall | 20A |
| 21. Open and close valve | 21A |
| 22. Open and close valve | 22A |
| 23. Open and close valve | 23A |
| 24. Open and close valve | 24A |
| 25. Nozzle | 25A |
| 26. Nozzle | 26A |
| 27. Open and close valve | 27A |
| 28. Open and close valve | 28A |
| 29. Smoke Hole mechanism | 29A |
| 30. Smoke Hole mechanism | 30A |

Numerical equipment list for the Smoke Hole System integrated in a DC-10-30-F aircraft. “A” designation after a code means lower deck location.

Locations:

| | | | |
|---|---|---|---|
| Plan view | Plan view | Side view | Cross views |
| Upper level | Lower level | | |

| | |
|---|---|
| 31. Open and close valve | 31A |
| 32. Open and close valve | 32A |
| 33. Open and close valve | 33A |
| 34. Open and close valve | 34A |
| 35. Three-way open and close valve | 35A |
| 36. Three-way open and close valve | 36A |
| 37. Nozzle | 37A |
| 38. Nozzle | 38a |
| 39. Three-way open and close valve | 39A |
| 40. Three-way open and close valve | 40A |
| 41. Nozzle | 41A |
| 42. Nozzle | 42A |
| 43. Open and close valve | 43A |
| 44. Open and close valve | 44A |
| 45. Galley computer | 45A |
| 46. Nozzle | 46A |
| 47. Nozzle | 47A |
| 48. Three-way open and close valve | 48A |
| 49. Three-way open and close valve | 49A |
| 50. Open and close valve | 50A |
| 51. Open and close valve | 51A |
| 52. Open and close valve | 52A |
| 53. Open and close valve | 53A |
| 54. Smoke Hole mechanism | 54A |
| 55. Smoke Hole mechanism | 55A |
| 56. Open and close valve | 56A |
| 57. Open and close valve | 57A |
| 58. Open and close valve | 58A |
| 59. Open and close valve | 59A |
| 60. Nozzle | 60A |
| 61. Nozzle | 61A |
| 62. Three-way open and close valve | 62A |
| 63. Three-way open and close valve | 63A |
| 64. Open and close valve | 64A |
| 65. Open and close valve | 65A |

Numerical equipment list for the Smoke Hole System integrated in a DC-10-30-F aircraft. “A” designation after a code means lower level location.

Locations:

| | | | |
|---|---|---|---|
| Plan view | Plan view | Lower Deck | Cross views |
| Upper level | Lower level | | |

| | |
|---|---|
| 66. Nozzle | 66A |
| 67. Nozzle | 67A |
| 68. Three-way open and close valve | 68A |
| 69. Three-way open and close valve | 69A |
| 70. Open and close valve | 70A |
| 71. Open and close valve | 71A |
| 72. Smoke Hole mechanism | 72A |
| 73. Smoke Hole mechanism | 73A |
| 74. Open and close valve | 74A |
| 75. Open and close valve | 75A |
| 76. Open and close valve | 76A |
| 77. Open and close valve | 77A |
| 78. Three-way open and close valve | 78A |
| 79. Three-way open and close valve | 79A |
| 80. Nozzle | 80A |
| 81. Nozzle | 81A |
| 82. Open and close valve | 82A |
| 83. Open and close valve | 83A |
| 84. Nozzle | 84A |
| 85. Nozzle | 85A |
| 86. Open and close valve | 86A |
| 87. Open and close valve | 87A |
| 88. Open and close valve | 88A |
| 87. Open and close valve | 89A |
| 89. Open and close valve | 89A |

Other Functions:

(A) Route of Smoke being ex pulsed inside the flexible tubing.

(B) Smoke.

(C) Fire.

(D) Smoke in the atmosphere.

The operation of the computer controlled aircraft fire sprinkler system and smoke expulsion mechanism installed in a DC-10-30-F cargo aircraft is shown in a series of drawings from pages 16 to 44.

THE NUMERICAL EQUIPMENT LIST FOR THE SMOKE HOLE SYSTEM INTEGRATED IN A DC-10-30-F AIRCRAFT IS SHOWN ON PAGES 9, 10, AND 11.

### Smoke Movement Plan View Sheet 2 of 5 Page 22

1. The smoke (B) from a fire (C) enters nozzle 38 as seen on sheet 2 of plan view Page 22 between sections 2 and 5 of the aircraft.

2. The top of the two-way valve (34) is closed so no backtracking of the smoke or directional of smoke movement (A) is possible.

3. The right side of three-way valve (36) is closed so the smoke makes a left turn in flexible (6) in direction (A) inside the tubing.

4. The Smoke (B) continues its movement in the tubing and enters open two-way valve (32).

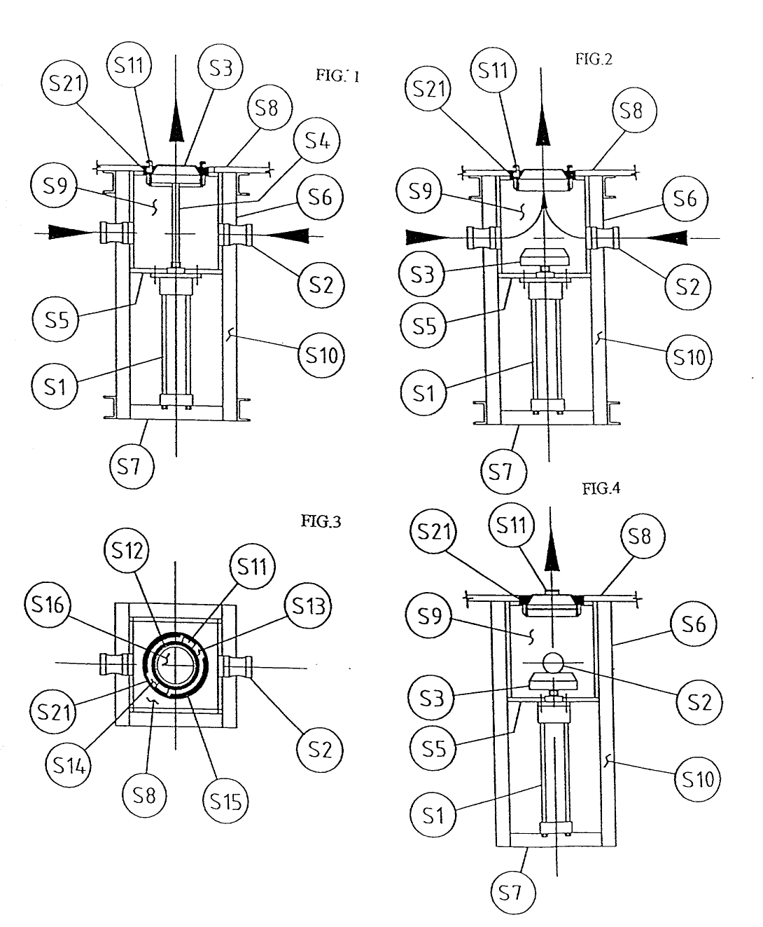

5. The (S 2) tubing hose connection mechanism seen on sheet 1 of 4 FIG. 2 Page 16 is a connection to both the Smoke Hole mechanism designated (S 30) and the open two-way valve (32) so unrestricted smoke entry inside the cavity zone (S 9) has now been achieved.

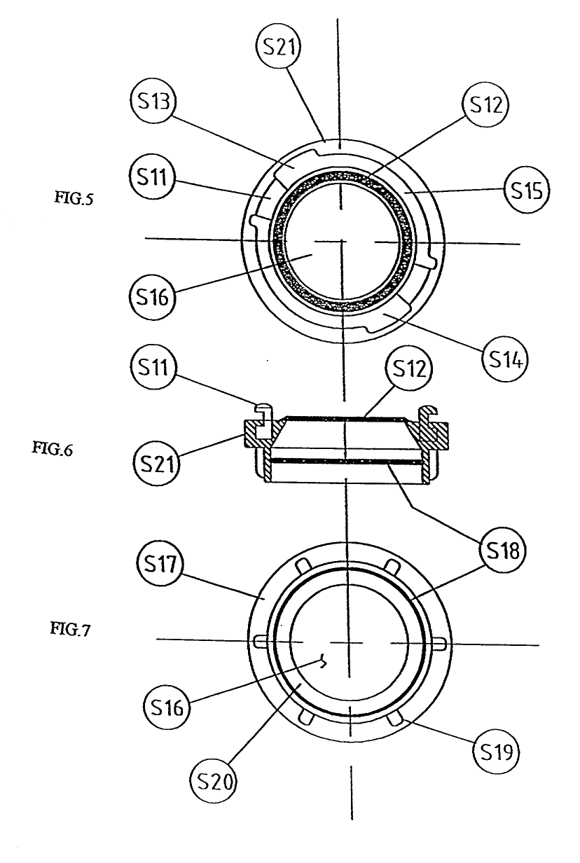

6. The right side of two-way valve (28) is closed so no smoke can escape cavity zone (S 9) as shown on sheet 1 of 4 FIG. (2). The pressurized smoke is now forced out of the aircraft via the porthole opening (S 16) see on sheet 1 of 4 FIG. 3 of the Smoke Hole mechanism parts Page 17.

The other side of the aircraft follows the same method of smoke expulsion for Smoke Hole (S-29).

### Smoke Movement—Plan View Lower Level Sheet 2 of 5 Page 28

1. The smoke (B) from a fire (C) enters nozzle (38 A) as seen on sheet 2 of 5 plan view lower level Page 28.

2. The top of the two-way valve (34 A) is closed so no backtracking of the smoke or directional of smoke movement (A) is possible.

3. The right side of three-way valve (36-A) is closed so the smoke makes a left turn in flexible (6) in direction (A) inside the tubing.

4. The Smoke (B) continues its movement in the tubing and enters open two-way valve (32).

5. The (S 2) tubing hose connection mechanism seen on sheet 1 of 4 FIG. 2 Page 16 is the connection to both the Smoke Hole mechanism designated (S 30A) on Page 28. The open two-way valve (32 A) on Page 28 permits unrestricted smoke entry inside the cavity zone (S 9) Page 16 so complete unhindered smoke expulsion is now possible.

6. The right side of two-way valve (28-A) is closed so no smoke can escape cavity Page 16 zone (S-9) as shown on sheet 1 of 4 FIG. (2). The pressurized smoke is now forced out of the aircraft via the porthole opening (S-16) see on sheet 1 of 4 FIG. 3 Page 16 for the Smoke Hole mechanism parts.

The other side of the aircrafts Smoke Hole Mechanism (29 A) follow the same method of smoke expulsion as above.

### Smoke Movement—Side View Sheet 2 of 5 Page 34

1. The smoke (B) from a fire (C) enters nozzle (38) as shown ob Side View sheet 2 of 5 plan.

2. The right hand side of the three-way valve (36) is closed so the smoke makes a left turn in the flexible tubing in the direction of the arrows.

3. The smoke enters open two-way valve (32).

4. The smoke enters Smoke Hole Mechanism (30) and the smoke is ejected in the direction of (D).

5. The right hand side of the two-way valve (28) is closed so no smoke can backtrack during the ejection process.

6. A close up of the smoke expulsion process can be seen on sheet 1 of 4 FIG. 2 page 16. The smoke enters the tubing Hose connection (S-2) moves swiftly into the cavity zone then swept outside via the open Porthole opening (S-16) shown on FIG. 3 of sheet 1 of 4 page 16.

### Cross Section View Sheet 4 of 5 Page 42

Smoke enters Nozzle (38) and moves to the right because open and shut valve (34) is closed the smoke turns right and enters the open portion of three-way valve (36) enters the tubing and into the cavity zone of Smoke Hole (30) and makes its ejection outside in the direction of (D).

The smoke ejection follows the same basic pattern for the other three Smoke Hole mechanisms (29)-(29 A) and (30 A).

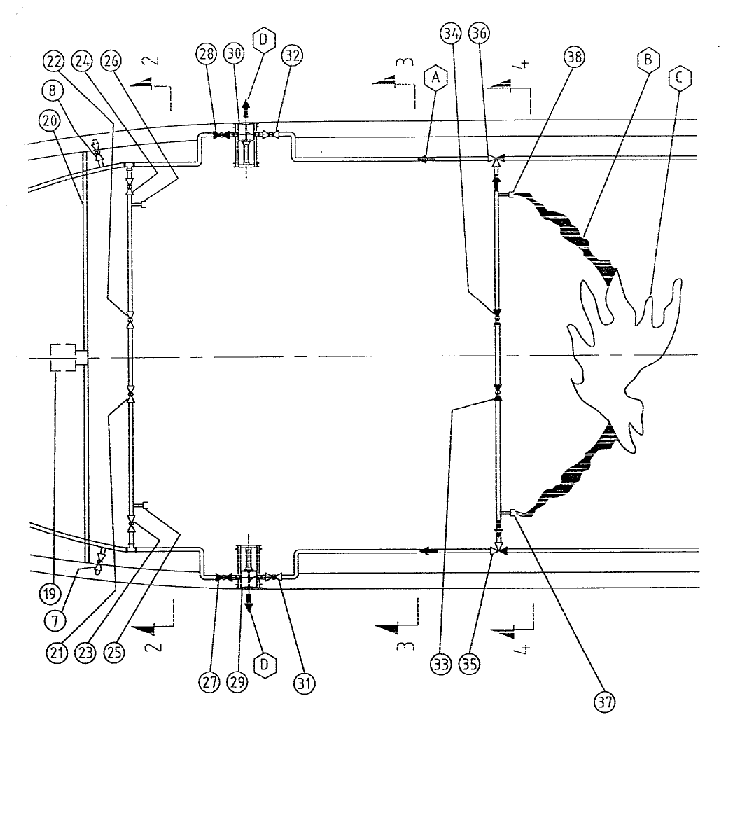

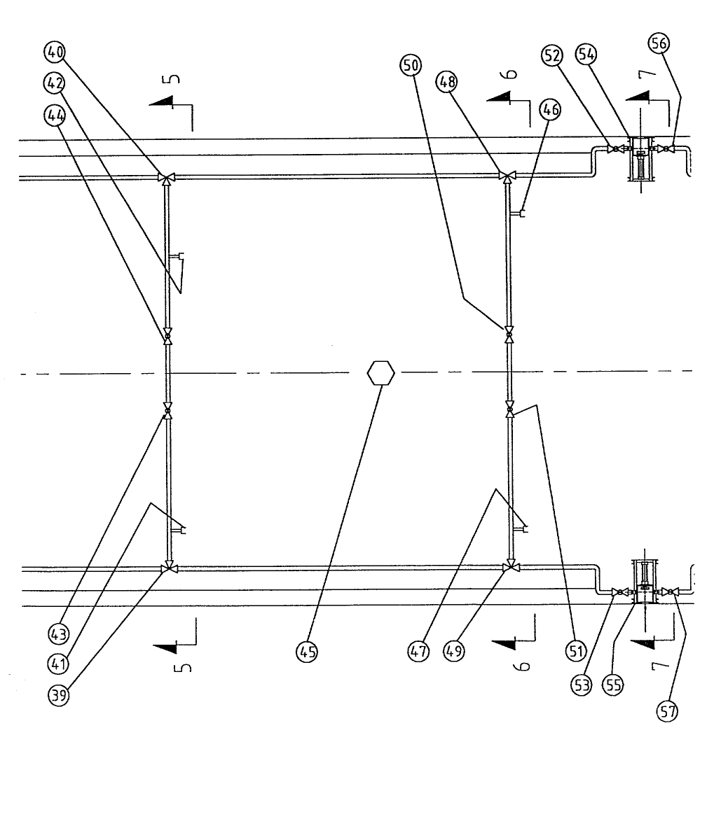

For water injection during Airport fire fighting sheet 3 of 4 FIGS. 8 and 9 shows the Airport fire hose approaching the aircraft in the Smoke Hole receiving area and sheet 4 of 4 FIGS. 10 and 11 page 19 we see the fire hoses (S 22) and the connecting Storz Adapter couplings (S 23) interlocks with the (S-16) Porthole opening seen in FIG. (3) of the same page.

On Page 42 sheet 4 of 5 we see four possible Hose entries for Fuselage wall connection into the aircraft and Smoke Hole (29 A) and (30-A) would in most cases be easier for Fire trucks and Hoses to make an interlocking connection however upper smoke Hole mechanism (29) and (30) would also be available in the event several sets of hoses were used simultaneously.

### Index

1—Title: Computer controlled Aircraft Fire Sprinkler System and Smoke Expulsion Mechanism.

2—Form 3: Petition for grant of a patent.

3—Abstract of the Disclosure.

4—Background of the Invention.

5—Diagram 1: A Smoke Hole Assembly Mechanism.

6—Background of the Invention.

7—Diagram 2: Shows 3 views of the Smoke Hole Assembly Mechanism and two Storz Reciprocal Adapters.

8—Background of the invention.

9—Parts designated for diagrams 1 and 2.

10—Parts designation for diagrams 3-4-5-6-7-8-8a-9-10.

11—Background of the Invention.

12—PARTS LIST FOR DIAGRAM:3

13—Diagram 3: Full Aircraft System for computerized Aircraft Fire Sprinkler System and Smoke Expulsion Mechanism.

The left diagram is the basic aircraft plumbing system. The right diagram is a potential layout for the electronic and computer hook-up of the equipment.

14—Description of the invention.

15—Diagram 4: An enlarged diagram of the top half of diagram 3.

16—Diagram 5: An enlarged diagram of the bottom half of diagram 3.

NOTE: DIAGRAMS ARE NUMBERED AT THE TOP OF THE PAGE PAGES ARE NUMBERED AT THE BOTTOM

17—Description of the Invention.

18—Description of the Invention.

19—Diagram 6: The top half is a section of the faucet and valve system above the ceiling.

The bottom half is a doctored photo of the cabin area showing the faucets in the ceiling.

20—Description of the diagram.

21—Diagram 7: The Fuselage Wall Faucet.

22—Diagram 8: Fuselage Wall Faucet.

23—Diagram 8a: Fuselage Wall Faucet.

24—Diagram 9: Fuselage Wall Faucet.

25—Diagram 10: Enlarged view of the left side of section 1 and 2 near the flight deck wall.

26—Diagram 11: A photo of a flight attendant at the controls of the passenger air conditioning and personal comfort computer.

27—Diagram 12: A doctored photo close-up of diagram 11. The computer has a superimposed layout of the computerized system for showing which valves are operational on a layout similar to DIAGRAM:3

28—Diagram 13: Photos and layout of a flight deck.

29—Diagram 14: Shows a technician operating an integrated Aircraft Systems Laboratory computer.

30—Diagram 15: Aircraft Military Standard.

Pressure Hoses:

Colour coding chart for Plumbing Lines.

31—Diagram 16: 157SE Electric Fire Fog Nozzle and other models.

32—Diagram 17: Photos and diagrams of a Storz Adapter installed in the prototype mechanism of a Smoke Hole Assembly Mechanism.

33—Diagram 18: Water injection into the Smoke Hole Mechanism

34—Diagram 19: A sample Open and Close valve

Claims: Seven claims on three pages.

1. The subject matter of the smoke hole mechanism is described as an integral part of the operational embodiment of the mechanism within the prior arts framework of a DC-10-30-F aircraft to facilitate fill understanding of the proposed system but not as a production boundary for any other aircraft that is capable of incorporating this system accordingly keeping in mind the proposal regardless of how the system or portions thereof will actually be fitted inside the aircraft.

2. The system of claim 1 wherein a network of flexible tubing is used to expel smoke at high altitudes and this same system of tubing is used as a connecting medium for the application of fire hoses following an on fire landing at an Airport whereby the interior of the plane will be sprayed with water drenching the Passengers but preventing them from burning while reducing the chances of an explosion and causing less damage to the Aircraft than by previous methods.

3. The system of claim 2 and a suggestion that an ever increasing degree of uniformity be applied by the various control agencies such as the FAA and IATA with regard to the reciprocal adapters used in the prototype of this invention namely Storz Adapters made by the AWG firm in Germany or licenced manufacturing rights films such as Nortline Couplings of Mississauga, Ontario keeping in mind that the reciprocal nature of the adapter inside the invention and the outside fire hose must be maintained.

4. The system of claim 2 and the proposal that total controls of the operation of this system must be done from the Flight Deck which controls all the pistons, valves, nozzles and related equipment following some prior arts alarm system that establishes that a serious fire is in progress and will be the signal opening feature that will put the proposed system in operation.

5. The system of claim 4 and the proposal that nozzles in the main cabin are set in a visible but unobtrusive area of the ceiling for the passenger level or the cargo or other operational level of the aircraft and that a certain number of extension nozzles are enclosed in the flight deck wall particularly the flight deck instrument wall that houses much wiring to avoid an electrical fire at its outside by the use of these nozzles which can suck the available oxygen in such a confined space thus curtailing the fire at the earliest possible stage avoiding a smoke filled flight deck that was a major contribution factor in the crash of Swissair Flight 111.

6. The system of claims 1 to 5 and the further provision that the Pilot may intervene the computer operated system at any time which may occur just before he vacates a plane that is on fire should he recognize by experience that the fire is not likely to reach the flight deck itself so he will thereby exclude any fire nozzle in the flight deck area from submitting a water sprinkling on the flight deck reducing the salvage claim on the aircraft by several million of dollars.

7. The system of claim 6 and the additional proposal that the computer screen that is used in the galley by the flight attendants to control individual seat air-conditioning be given the added responsibility of monitoring the operation of the proposed system so that a malfunction in the system would appear on the screen but this unit would not be an activation computer unless for some reason the flight deck computer could no longer function which would be a transformation signal for the galley computer to become an activation computer.

8. The system of claim 6 and the additional proposal that the computer with its incredible ability to perform repetitive and logical tasks be utilized to determine the exact source of a fire even if the fire is not visible to the eye by determining which shut-off valves are operational and the direction the smoke is taking as it routes its way out of the tubing to the nearest exit by the nearest or most convenient Smoke Hole mechanism.
